(19) United States
(12) Patent Application Publication
(10) Pub. No.: US 2012/0145732 A1
(43) Pub. Date: Jun. 14, 2012

(54) INSULATION SLEEVE FOR A HEATED BEVERAGE CUP

(76) Inventors: Steven Padek, Carmel, IN (US); David K. Whitinger, Dexter, MI (US)

(21) Appl. No.: 13/323,171

(22) Filed: Dec. 12, 2011

Related U.S. Application Data
(60) Provisional application No. 61/421,783, filed on Dec. 10, 2010.

(51) Int. Cl. B65D 25/20; B31C 11/00; B31C 7/02; B31C 99/00

(52) U.S. Cl. 220/738; 220/739; 493/269; 493/270; 493/291; 493/296

(57) ABSTRACT

An insulation sleeve for a heated beverage cup. The sleeve is formed from spathes of a raw husk material, such as corn husk. The spathes are attached such that end portions of the spathes overlap to form a generally circular form sized to fit about and vertically support a typical frustoconical beverage cup. The sleeve may be further formed to have a generally frustoconical shape to fit the corresponding frustoconical shape of the beverage cup. The spathes may be dampened to assist in forming the sleeve into the circular or frustoconical shape.

### CROSS REFERENCE TO RELATED APPLICATIONS

This application claims the benefit of U.S. Provisional Patent Application No. 61/421,783 filed Dec. 10, 2010, which is hereby incorporated by reference.

### FIELD OF THE INVENTION

The present disclosure relates generally to beverage containers, and more specifically, to an insulation sleeve for a heated beverage cup.

### BACKGROUND

Various types of disposable cups are known in the art for use with beverages. In order to reduce manufacturing costs and shipping weight, such cups are typically thin and do not provide sufficient insulation to protect a user's hand when holding a hot beverage, such as coffee or tea. To combat this problem, insulating sleeves are typically made available at the place of purchase for use with the cup. However, the sleeves have a detrimental impact on the environment due to the increased energy and environmentally harmful processes required to manufacture the sleeve material, which typically consists of cardboard or polystyrene. Furthermore, even paper-based sleeve materials such as cardboard are not fully biodegradable and require costly procedures in order to be safely recycled or disposed of. Improved cup sleeves are therefore needed which provide sufficient insulation and, at the same time, have a reduced environmental impact in relation to both manufacturing and disposal.

### SUMMARY

According to one aspect, an insulation sleeve for holding a frustoconical beverage cup is disclosed. The insulation sleeve comprises a first husk spathe and a second husk spathe, the first and second spathes having an elongated shape. The end portions of the first and second spathes are attached together in a partially overlapping arrangement to form a substantially circular shape. An interior diameter of the sleeve is sized to fit about an exterior diameter of the frustoconical beverage cup such that the sleeve vertically supports the frustoconical beverage cup when held by a user. The insulation sleeve may be configured in a frustoconical shape to substantially correspond to the frustoconical beverage cup. The insulation sleeve may be pressed upon a frustoconical molding device to achieve the frustoconical shape. To assist in the forming process, the spathes may be dampened before or during assembly of the insulation sleeve. The spathes may be attached together using thread or adhesive, or other fasteners known in the art. A graphic may be applied to an exterior surface of the sleeve.

According to another aspect, a method of manufacturing an insulation sleeve for a beverage cup is disclosed, comprising attaching a first end of a first corn husk spathe and a second end of a second corn husk spathe in a partially overlapping fashion, and attaching a third end of the first corn husk spathe to a fourth end of the second corn husk spathe in a partially overlapping fashion to form a substantially circular shape. An interior diameter of the sleeve is sized to fit about an exterior diameter of the frustoconical beverage cup such that the sleeve vertically supports the beverage cup when held by a user. The method may also include pressing the first and second spathe onto a frustoconical molding device to form the sleeve into a substantially frustoconical shape and/or dampening the first and second corn husk spathes to assist in the forming process.

### BRIEF DESCRIPTION OF THE DRAWINGS

FIG. 1 depicts a front view of an insulation sleeve installed about a beverage cup according to one embodiment of the present disclosure.

FIG. 2 depicts a front view of two spathes of a husk material in a first stage of assembly of the insulation sleeve of FIG. 1.

FIG. 3 depicts a front view the two spathes of a husk material in a second stage of assembly of the insulation sleeve of FIG. 1.

FIG. 4 depicts a front view of two spathes of a husk material in a third stage of assembly of the insulation sleeve of FIG. 1.

FIG. 5 depicts a front view of two spathes of a husk material in a fourth stage of assembly of the insulation sleeve of FIG. 1.

FIG. 6 depicts a perspective view of the insulation sleeve of FIG. 1 in a fifth stage of assembly.

FIG. 7 depicts a front view of the insulation sleeve of FIG. 1 being molded upon an inverted frustoconical molding device.

FIG. 8 depicts a top view of an insulation sleeve according to a further embodiment of the present disclosure.

FIG. 9 depicts a perspective view of an insulation sleeve according to a further embodiment of the present disclosure.

FIG. 10 depicts a top view of an insulation sleeve which has been collapsed to a substantially flat form.

FIG. 11 depicts a perspective view of a plurality of insulation sleeves stacked in a nested column arrangement.

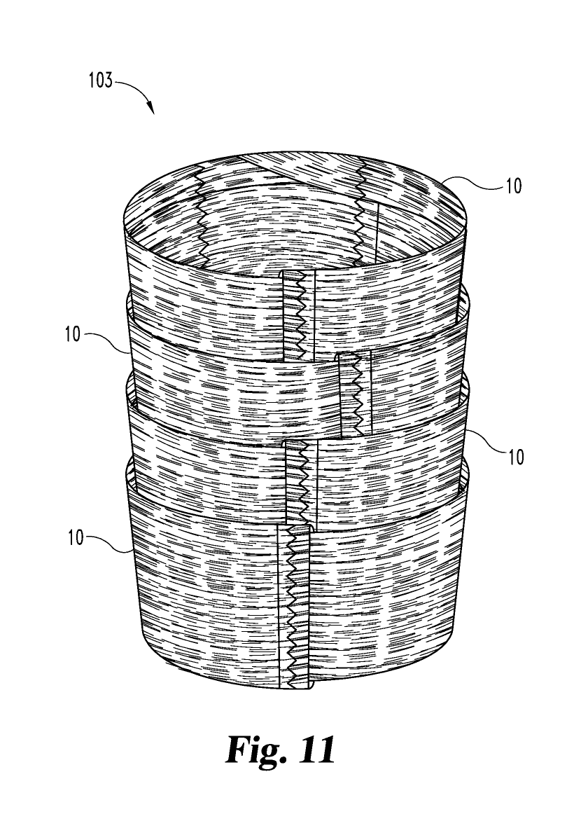

### DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

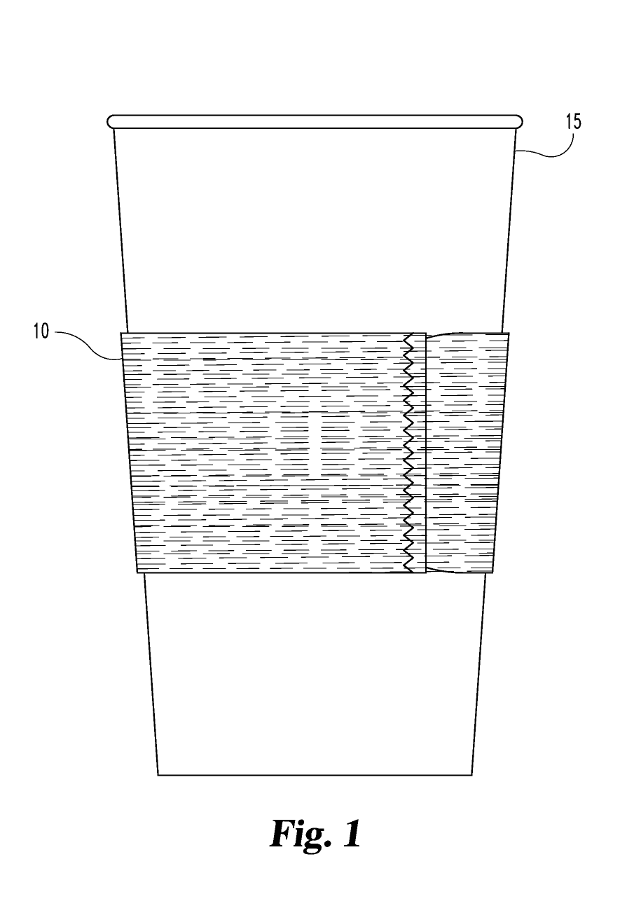

Referring to FIG. 1, there is shown a front view of an insulated sleeve 10 for a beverage cup 15 according to a preferred embodiment of the present disclosure. The sleeve 10 is formed from a raw husk material, such as a corn husk. Because the husk material is completely non-toxic, biodegradable, and typically considered a waste product from existing farming operations, it has very little impact on the environment from both a manufacturing and disposal perspective. As discussed further below, the sleeve 10 is formed in a generally circular form to fit around a typical frustoconical beverage cup, such as those used in many fast food restaurants and coffee shops. The sleeve 10 may further be formed in a generally frustoconical or downwardly-tapering shape and sized to correspond to the frustoconical beverage cup.

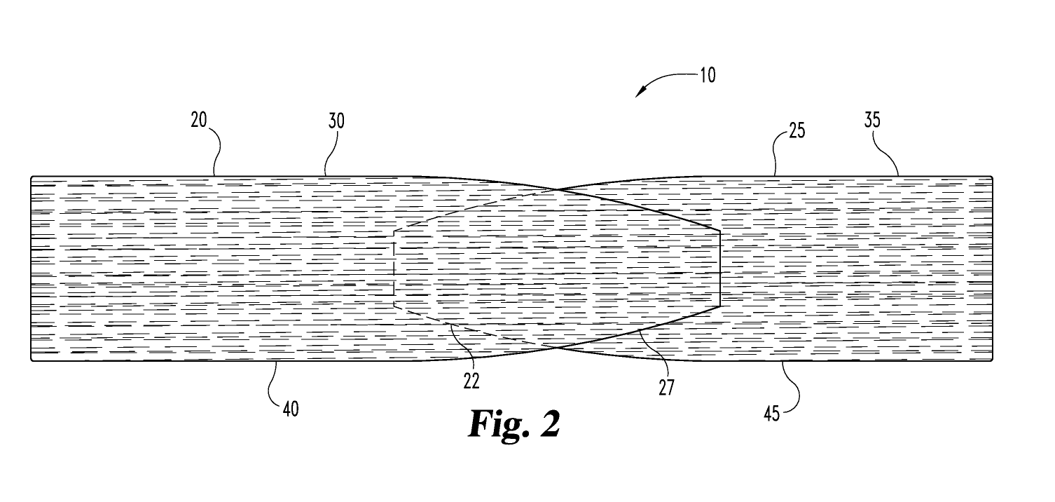

The sleeve 10 is preferably formed by stacking a first husk spathe 20 and a second husk spathe 25 in an opposing partially overlapping fashion as shown in FIG. 2, with the naturally narrowing end portions 22 and 27 of the spathes overlapping. The spathes 20 and 25 may preferably be dampened with water or steam in order to allow greater flexibility and prevent cracking during the assembly process. Additional spathes may be used to form layers within the sleeve and increase the insulative effect.

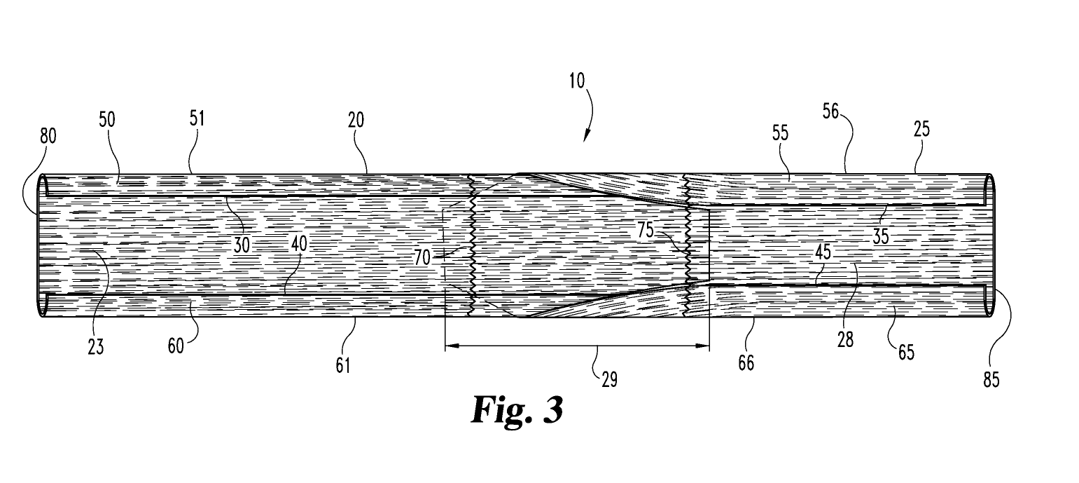

Next, the upper edges 30 and 35 and lower edges 40 and 45 are folded inward to form flaps 50, 55, 60, and 65 as shown in FIG. 3. The desired height of the sleeve 10 may be achieved by adjusting the amount of material used to form the flaps. The flaps 50, 55, 60, and 65 serve to provide reinforced edges 51, 56, 61, and 66 which are less prone to tearing and less likely to irritate or cut a user's fingers. The flaps also create additional air pockets which contribute to the insulating effect of the sleeve 10.

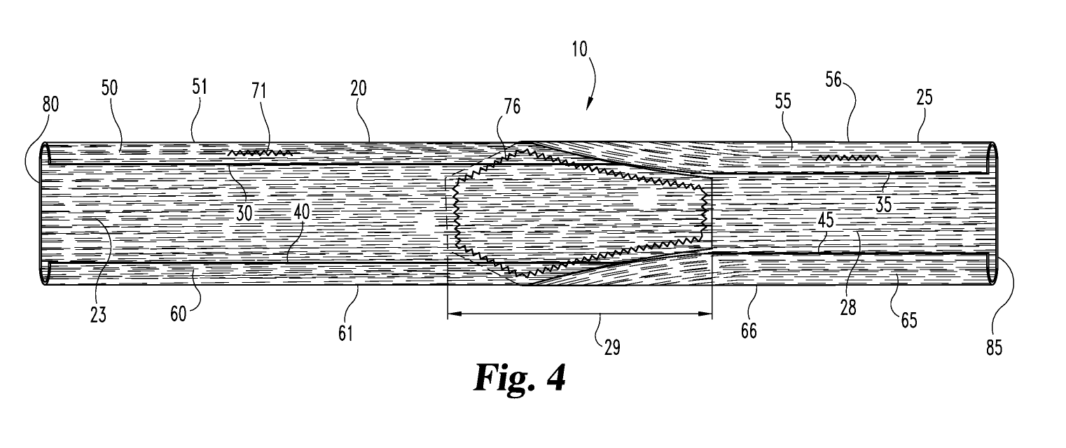

Stitching 70 and 75 may be applied as shown to hold the flaps 50, 55, 60, and 65 flat against the central body portions 23 and 28 of spathes 20 and 25 and maintain the relative arrangement of the spathes 20 and 25. The stitching 70 and 75 is preferably made of cotton thread, although other types of thread material may be used. The stitching 70 and 75 is preferably done in a zigzag pattern to provide additional protection against tearing of the husk material. Other types of stitching may also be used, such as chain stitching and lock stitching. In certain embodiments, the stitching is applied in vertical strips as shown in FIG. 3. In other embodiments, stitching 71 and 76 is applied in an overall horizontal or angled direction, following the edges of the spathe material, as shown in FIG. 4.

In other embodiments, an adhesive may be applied to an interior surface of the flaps 50, 55, 60, and 65 to secure the flaps to the body portions 23 and 28. The adhesive is preferably a water-based food-grade adhesive having suitable flexibility to maintain adhesion as the sleeve 10 flexes during assembly, shipping and use. The adhesive may also be applied between the overlapping portions 29 of the spathes 20 and 25 to secure the spathes 20 and 25 together. It still further embodiments, the adhesive may be applied to the entire spathes 20 and 25 to provide a smooth and more comfortable coating when handled. The adhesive may also be used to soften the spathes 20 and 25 instead of or in addition to water.

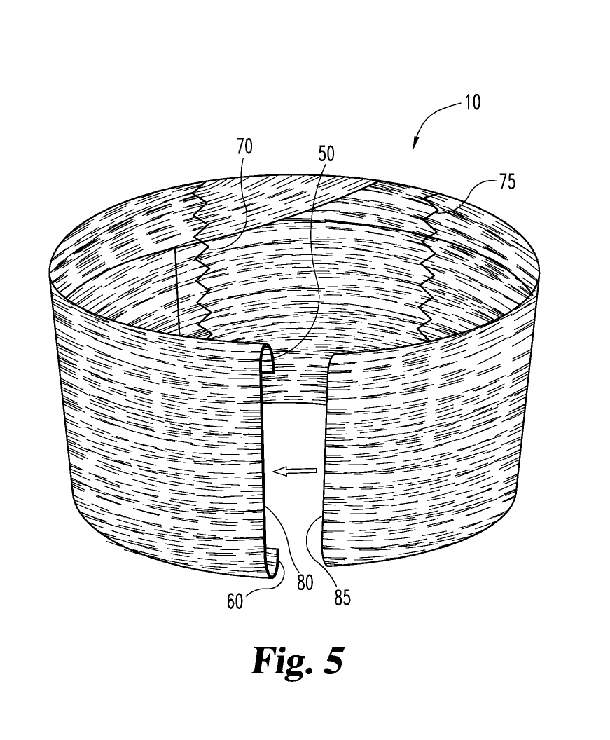

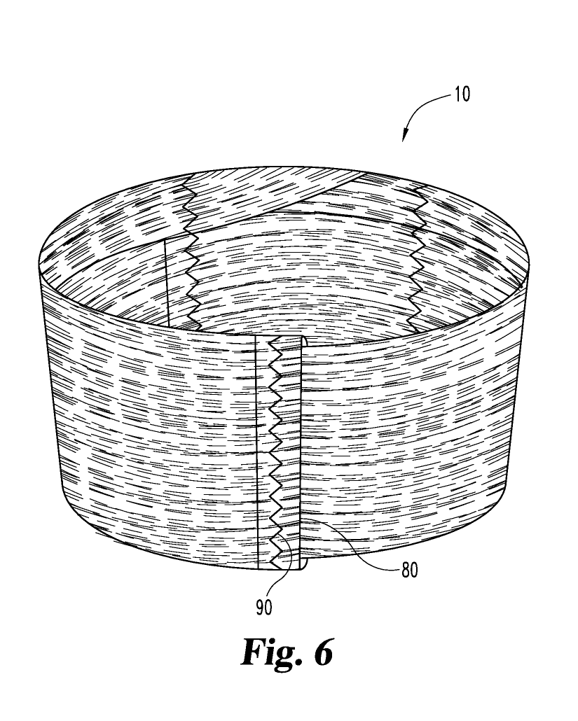

Turning to FIG. 5, the spathes 20 and 25 are formed into a generally circular shape, with the end portions 80 and 85 in close proximity to one another. The end portion 85 is then tucked into the end portion 80 such that the flaps 50 and 60 partially enclose the end portion 85. Stitching 90 may then be applied through the spathes 20 and 25 as shown to secure the end portion 85 within the end portion 80 as shown in FIG. 6. In other embodiments, an adhesive may be applied to the end portion 85 to secure the end portions 80 and 85 together. The end portions 80 and 85 may be held together using sufficient pressure for a sufficient time to allow the adhesive to set up and maintain the bond between the end portions 80 and 85.

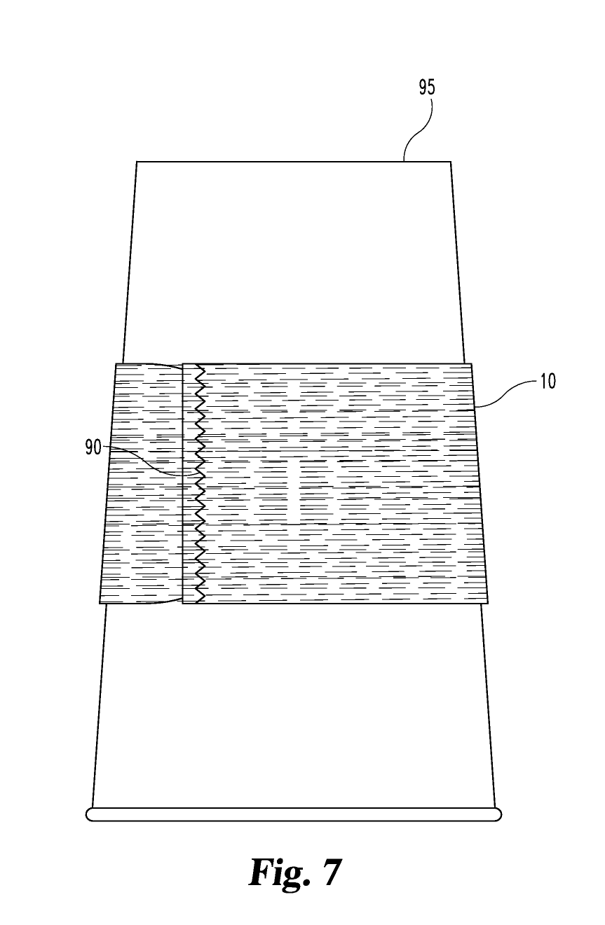

Turning to FIG. 7, the sleeve 10 may be formed into a frustoconical shape by placing the dampened sleeve 10 onto a frustoconical molding device 95 with sufficient pressure to stretch the husk material and allow it to partially dry. The molding device 95 may be sized to match the size and shape of the drinking cups which will eventually be used with the sleeve 10. In one embodiment, the molding device 95 may comprise a frustoconical drinking glass placed upside down. Drying time may be decreased by applying hot air to the sleeve 10 while still mounted on the molding device 95. In certain embodiments, the sleeve 10 may be removed from the molding device before drying in order to increase production speed. In such cases, the overall diameter of the dampened sleeve 10 and molding device 95 may be optionally increased to account for shrinkage that can occur as the spathes 20 and 25 dry out. In certain embodiments, stitching 90 may be applied after forming the sleeve 10 onto the molding device 95 in order to further encourage the sleeve to maintain the frustoconical shape once the stitching 90 is applied. If adhesive is used, the sleeve 10 may be placed onto the frustoconical molding device 95 before the adhesive is set up or cured, allowing the adhesive to develop its bond while the sleeve 10 is held in the frustoconical shape. It shall be understood that molding devices having shapes other than a frustoconical shape may also be used, such as cylinders or other suitable sleeve shapes.

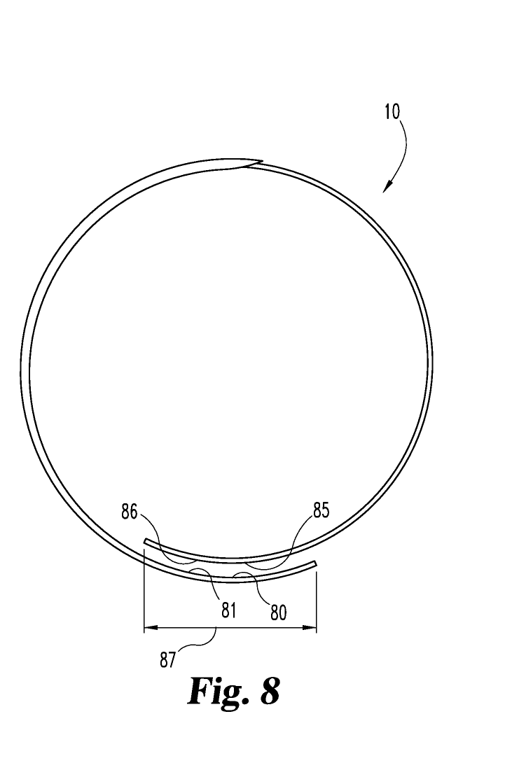

In other embodiments, instead of tucking the end portion 85 into the flaps 50 and 60, the end portions 80 and 85 may simply be overlapped as shown in FIG. 8. Adhesive may then be applied to the mating surfaces 81 and 86 in the overlap area 87 before or while the sleeve 10 is being applied to the frustoconical molding device 95 to secure and maintain the frustoconical shape of the sleeve 10.

Once dry, the sleeve 10 will tend to retain its circular and frustoconical shape. In addition, the dried husk material will provide increased insulative properties, due to the air gaps formed between the cup and the naturally-uneven splined surface of the husk. The sleeve 10 is durable enough to be reused multiple times, although eventual disposal of the sleeve has very little impact on the environment, as the husk material will naturally decompose once exposed to soil or other natural waste environment.

The rigidity and texture of the dried sleeve 10 also provides a suitable surface to apply a graphic, logo, or other advertising material using ink. Various types of ink or dye may be used, including solvent-based and water-based inks In a preferred embodiment, pad printing may be used to apply the graphic to the sleeve 10. In addition to ink-based processes, the graphic may be applied using laser etching, heat branding (burning), dry film, decals, or other processes known in the art. The graphic or logo may also be embroidered or sewn into the husk material.

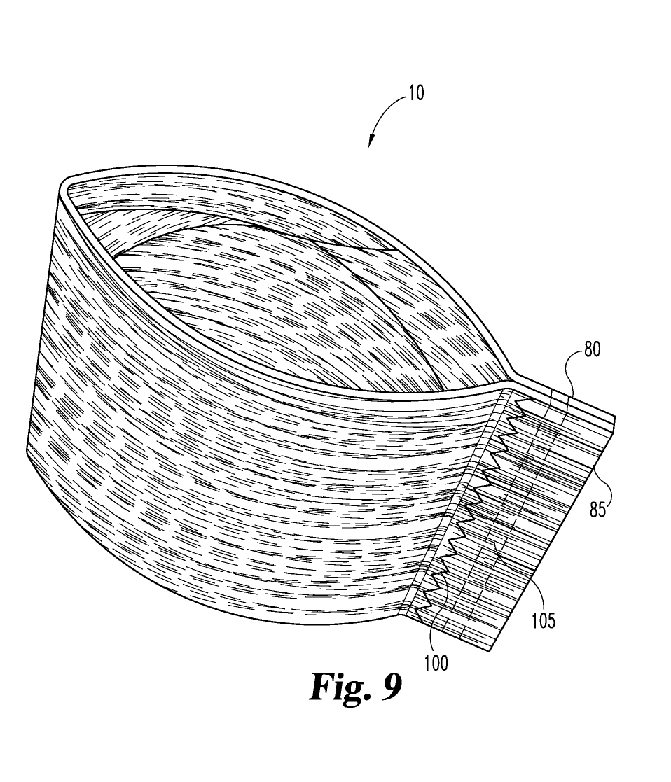

FIG. 9 shows another embodiment wherein the end portions 80 and 85 are not tucked or overlapped, but rather are gathered against one another by contacting the interior end surfaces of both spathes 20 and 25 as shown. This allows stitching 100 to be easily applied across the gathered portions of the spathes, since the sewing apparatus does not need to be inserted through the interior cavity of the sleeve 10. Once the stitching 100 has been applied, the excess portion 105 which is outside of the stitching 100 may be trimmed off to provide a more uniform circular shape if desired. Alternatively, the excess portion 105 may be left in place in order to form the basis for a handle or an additional area to place a graphic or advertising message.

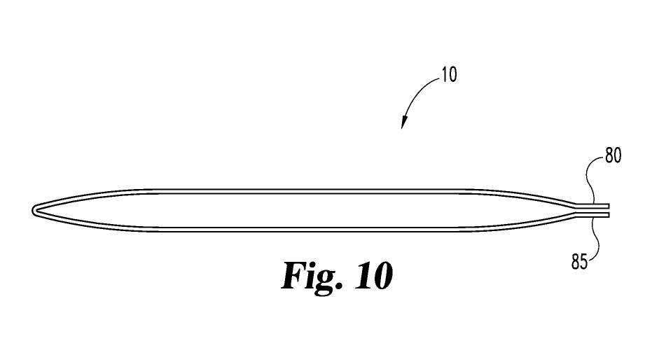

In certain embodiments, the sleeve 10 may be collapsed into a fully or partially flattened arrangement while still damp in order to allow for more compact shipping and storage as shown from a top view in FIG. 9. When ready for use, the collapsed sleeve 10 may be expanded and restored to its circular or frustoconical shape. In other embodiments, the sleeve 10 may be left in a frustoconical shape during shipping with multiple sleeves 10 nested into columns 103 as shown in FIG. 10, or simply placed loosely within a container, such as a biodegradable burlap bag.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. An insulation sleeve for holding a frustoconical beverage cup, comprising:
a first husk spathe; and
a second husk spathe, the first and second spathes having an elongated shape;
wherein end portions of the first and second spathes are attached together in a partially overlapping arrangement to form a substantially circular shape; and
wherein an interior diameter of the sleeve is sized to fit about an exterior diameter of the frustoconical beverage cup such that the sleeve vertically supports the frustoconical beverage cup when held by a user.

2. The insulation sleeve of claim 1,
wherein the first and second husk spathes comprise corn husk spathes.

3. The insulation sleeve of claim 1,
wherein the insulation sleeve is configured in a frustoconical shape to substantially correspond to the frustoconical beverage cup.

4. The insulation sleeve of claim 1,
wherein the insulation sleeve is pressed upon a frustoconical molding device to achieve a frustoconical shape.

5. The insulation sleeve of claim 1,
wherein the spathes are dampened before or during assembly of the insulation sleeve.

6. The insulation sleeve of claim 1,
wherein the spathes are attached together using thread.

7. The insulation sleeve of claim 1,
wherein the spathes are attached together using an adhesive.

8. The insulation sleeve of claim 7,
wherein the adhesive is applied to overlapping portions of the first and second spathes prior to the spathes being pressed upon a frustoconical molding device to achieve a frustoconical shape.

9. The insulation sleeve of claim 7,
wherein the adhesive is applied to the first and second spathes while the spathes are being pressed upon a frustoconical molding device to achieve a frustoconical shape.

10. The insulation sleeve of claim 1,
wherein at least a portion of opposing lengthwise edges of the second spathe are folded inward to form opposing flaps.

11. The insulation sleeve of claim 10, wherein the flaps are secured to a central body portion of the spathe.

12. The insulation sleeve of claim 10,
wherein a first end portion of the first spathe is overlapped within a second end portion of the second spathe, the opposing flaps of the second spathe partially enclosing the first end portion of the first spathe.

13. The insulation sleeve of claim 1,
wherein a graphic is applied to an exterior surface of the sleeve.

14. The insulation sleeve of claim 13,
wherein the graphic is applied using pad printing.

15. An insulation sleeve for holding a frustoconical beverage cup, comprising:
a first husk spathe; and
a second husk spathe, the first and second spathes having an elongated shape;
wherein a first end of the first spathe and a second end of the second spathe are attached together in a partially overlapping fashion; and
wherein interior surfaces of a third end of the first spathe and a fourth end of the second spathe are attached together to allow the sleeve to be collapsed into a substantially flattened arrangement;
wherein an interior diameter of the sleeve when expanded is sized to fit about an exterior diameter of the frustoconical beverage cup such that the sleeve vertically supports the frustoconical beverage cup when held by a user.

16. A method of manufacturing an insulation sleeve for a frustoconical beverage cup, comprising:
attaching a first end of a first corn husk spathe and a second end of a second corn husk spathe in a partially overlapping fashion; and
attaching a third end of the first corn husk spathe to a fourth end of the second corn husk spathe in a partially overlapping fashion to form a frustoconical shape;
wherein an interior diameter of the sleeve is sized to fit about an exterior diameter of the frustoconical beverage cup such that the sleeve vertically supports the beverage cup when held by a user.

17. The method of claim 16, further comprising:
pressing the first and second spathe onto a frustoconical molding device to form the sleeve into the frustoconical shape.

18. The method of claim 16, further comprising:
dampening the first and second corn husk spathes.

19. The method of claim 16, further comprising:
applying a graphic to an exterior surface of the insulation sleeve.
